(19) United States
(12) Patent Application Publication
(10) Pub. No.: US 2007/0194230 A1
(43) Pub. Date: Aug. 23, 2007

(54) INSPECTION INSTRUMENT OF A MAGNETIC SPECIMEN

(76) Inventors: Teruo KOHASHI, Hachioji (JP); Tomokazu Shimakura, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/672,617

(22) Filed: Feb. 8, 2007

(30) Foreign Application Priority Data
Feb. 22, 2006 (JP) 2006-044875

(51) Int. Cl. G21K 7/00

(52) U.S. Cl. 250/310

(57) ABSTRACT

An inspection technique capable of observing a magnetic domain configuration which is formed on a magnetic specimen surface with a higher resolution and at a higher speed as never before. The inspection technique includes an SPLEEM observation unit including a spin polarized electron source, an irradiation optics that projects a spin polarized electron beam that is emitted from the spin polarized electron source to a magnetic specimen having a magnetic domain structure, a stage on which the magnetic specimen is mounted, an imaging optics that focuses and detects the electron beam that is reflected from the magnetic specimen; and cleaning means for cleaning the surface of the magnetic specimen to transfer the magnetic specimen to the SPLEEM observation unit, wherein the magnetic domain structure of the magnetic specimen surface is inspected on the basis of the reflected electron beam.

### CLAIM OF PRIORITY

The present application claims priority from Japanese application JP 2006-044875 filed on Feb. 22, 2006, the content of which is hereby incorporated by reference into this application.

### FIELD OF THE INVENTION

The present invention relates to an inspection technology of a magnetic specimen such as a magnetic disk having a magnetic material on a surface thereof.

### BACKGROUND OF THE INVENTION

A magnetic recording instrument is incorporated into a personal computer or a video cassette recorder, and the production volume of a magnetic disk or an optical disk which is a medium of the magnetic recording instrument tends to increase. Also, an MRAM (magnetic random access memory) has been actively developed as a next-generation semiconductor device.

As the high density and the integration of the magnetic device such as the magnetic disk or the MRAM is more advanced, a magnetic domain size within the magnetic device is minimized with the result that it is important to control the magnetic domain structure. For example, in a hard disk, the magnetic domain having a bit length 30 nm level has been produced in year 2005, and as the bit length is more shortened in the future, a sufficient S/N is not obtained unless the bit configuration is controlled in the level of 10 nm or lower. That is, there is a fear that even the deformation of the magnetic domain in a fine range as never before disturbs the reproduction of recorded information. From this viewpoint, there has been required the inspection technology of the magnetic domain structure on the magnetic device which is higher in the resolution as never before.

As the conventional magnetic domain structure inspection that has problems with the reproduction of recorded information, a Kerr microscope or an MFM (magnetic force microscopy) has been employed. However, because the Kerr microscope is a device using a visible light, its resolution remains in the level of 1 μm, which is insufficient in the current magnetic device evaluation. The commercial MFM is about 40 nm in the resolution which is not also sufficient. Further, it takes about 10 minutes to obtain a single sheet of image, and it takes time to specify and analyze a defective portion. As a result, the commercial MFM is insufficient as the future device inspection instrument.

On the other hand, there has been known a SPLEEM (spin polarized low energy electron microscopy) as a magnetic domain observation method that is high in resolution and high in processing speed (for example, refer to Journal of Physics D: Applied Physics 35, pp. 2327-2331 (2002)). This method projects a spin polarized electron beam to a specimen at a low speed (several eV), and collects elastic scattering electrons to obtain an image, thus achieving the resolution of 10 nm level. Also, since electron beams that are relatively large in the diameter (several μm to several tens μm) are projected through the projection method to obtain the image, the image obtaining time is remarkably shorter than that of the scanning microscope, and has been known as a very high speed of about 1 second.

### SUMMARY OF THE INVENTION

However, there is no example in which the above SPLEEM is applied to the evaluation of the magnetic device. This is because of such a principled program that a signal of the SPLEEM is not sufficiently obtained unless the surface of the magnetic material which is a specimen is clean at the atomic level and excellent in the crystallinity. For that reason, up to now, the SPLEEM is used for only a basic study such as observation of the specimen that is produced within a vacuum chamber. A specimen having a protection layer on a surface thereof and a specimen having an oxidized layer formed by exposure into the atmosphere once are not observed, and it is considered difficult to evaluate the magnetic device.

The present invention has been made to solve the above drawbacks, and therefore an object of the present invention is to provide an inspection technology that is capable of observing a magnetic domain structure which is formed on the surface of a magnetic specimen with a higher resolution and at a higher processing speed as never before.

In order to achieve the above object, according to the present invention, there is provided a magnetic specimen inspection instrument comprising: cleaning means for cleaning a surface of a magnetic specimen (a magnetic disk, an MRAM, etc.); a magnetic domain observing unit of a SPLEEM system which observes a magnetic domain that is formed on the surface of the magnetic specimen; and an image processing unit that analyzes obtained image data.

The means for cleaning the magnetic specimen surface is further classified into one portion for peeling off a surface protection layer due to oxygen plasma ashing, and another portion for conducting ion milling which peels off a layer caused by stain such as an oxidized layer on the surface. Those two portions are installed into individual vacuum chambers, and normally partitioned by a gate valve in such a manner that the specimen can be transferred between those portions by opening the valve through no atmosphere. The vacuum chamber in which the oxygen plasma ashing portion is installed includes a load lock.

The specimen is inserted from the specimen introduction chamber, and is first set up in the vacuum chamber that conducts the oxygen plasma ashing. For example, in the case of a hard disk, the outermost layer of the disk may be made of an organic matter such as a carbon protection layer or a lubricating film. Those films can be removed by conducting the oxygen plasma ashing under an appropriate condition.

Thereafter, the specimen is transported to the vacuum chamber that conducts the ion milling. In the vacuum chamber, ions of argon or the like are milled to remove the oxidized layer of the specimen surface. In this situation, when the acceleration voltage of ions is too high, there is a fear that argon ions invade the interior of the specimen, and the crystal state of the specimen is changed, thereby making it necessary to conduct the ion milling at a lower acceleration of about 200 to 500 V. The fact that the specimen surface is satisfactorily cleaned can be finally confirmed through the SPLEEM observation, or can be confirmed by attaching an Auger analysis system to the vacuum chamber and investigating atoms of the specimen outermost layer.

Thereafter, the specimen is transferred to the vacuum chamber that conducts the SPLEEM observation. In the SPLEEM measurement, a sufficient S/N cannot be obtained unless the surface of the specimen is clean and excellent in the crystallinity as described above. For example, a recording layer of a hard disk which is, for example, currently commercially produced, as the magnetic specimen is of a polycrystalline structure. In order to ensure the magnetic anisotropy, the crystal axes of the respective crystal grains face in one direction, and the crystallinity of some degree is kept as a whole. Also, it is possible to clean the surface of the specimen by conducting the above-mentioned hydrogen plasma ashing or ion milling.

In this state, the hard disk is attached onto a rotary stage, and the SPLEEM observation is sequentially conducted while the specimen is being rotated and also moved in a radial direction, and a recording pattern on the hard disk is inspected. In the case where a detector is suitable for static observation such as a CCD (charge coupled device), it is desirable that the rotational motion is conducted by repeating motionlessness and motion little by little. On the contrary, in the case where the detector is adaptive to dynamic observation such as a TDI (time delay and integration) system, it is desirable to move the specimen without stoppage. There are proposed a system that moves the specimen so as to draw a polycircle by shifting the specimen in the radial direction by a field every time the specimen goes round, and a system that moves the specimen so as to draw a convolution by shifting the specimen in the radial direction bits by bits while rotating the specimen. Both of those systems are applicable to the present invention.

The configuration of the above respective vacuum chambers is one of examples proposed by the present invention. In another example, the vacuum chamber that conducts ion milling is omitted, and an ion gun is attached to the vacuum chamber that conducts the SPLEEM observation. The optical axis of the ion gun is adjusted while rotating the specimen that is attached to the rotary stage, and a portion on the specimen surface immediately before the SPLEEM observation is subjected to ion milling. In this system, while the hard disk is fixed in the radial direction and is quickly rotated, the ion milling and the SPLEEM observation are conducted several rounds in a short period of time. Then, it is observed which round a sufficient contrast is given to the SPLEEM image, thereby making it possible to confirm the appropriate amount of ion milling while conducting the SPLEEM observation. Once the appropriate amount of ion milling is confirmed, the specimen is then moved and rotated in the radial direction while conducting the appropriate amount of milling at a decreased rotating speed, thereby making it possible to inspect the entire surface of the hard disk media. In this system, not only the number of vacuum chambers is reduced, but also the trouble of confirming the milling conditions is saved.

Subsequently, an image data processing system will be described. The SPLEEM utilizes that the degree of reflection is changed according to a relationship between the orientation of a spin-polarized degree and the orientation of a magnetic vector at a portion to which incident electrons are projected. In other words, it is assumed that the number of reflected electrons is a signal. As a method of mapping the number of electrons two-dimensionally, there is proposed a detecting system such as the CCD or the TDI as described above. However, this system is associated with a system of actuating the rotary stage on which the hard disk is mounted. The obtained data can be observed as an image while the data can be processed as numerical data. Then, the system has a function of conducting a Fourier transformation in the circumferential direction or the radial direction of the rotary stage. As a result, it can be determined whether the recorded bit length is a given length, or not, and whether the track width is a given width, or not. In the case where those values are different from the given values, those values are registered as error portions. Through the above analyzing method, it is possible to precisely inspect the magnetization state of the entire disk at a high speed and with a precision.

However, in this situation, it is difficult to conduct the above numeric analysis unless a sufficient S/N is obtained. For that reason, since there is required an inspection time for ensuring the S/N as much as the above numeric analysis can be sufficiently conducted, one limit of throughput is determined according to the S/N. The defective portion that is specified by the above numeric analysis is recorded by a rotating coordinate system (r, θ), and carried over to a subsequent analyzing method such as a transmission electron microscope (TEM) or an X-ray analysis device (EDX).

As described above, the SPLEEM system that has been obtained by the present invention is used, thereby making it possible to implement the inspection of the data and the servo signal which have been recorded on the magnetic disk at a higher speed and with a higher resolution.

However, the applied field of the present invention does not remain in the magnetic disk. The rotary stage is replaced with an XY stage that is actuated horizontally and vertically, and its intended use can be expanded to the general magnetic devices, for example, so as to inspect an MRAM produced on a wafer. Similarly, in this case, the obtained data is subjected to the Fourier transformation in the X-direction or the Y-direction, thereby making it possible to analyze the defective portion.

According to the present invention, there can be provided an inspection technique that is capable of inspecting the magnification state of various magnetic specimens at a higher speed and with a higher resolution.

### BRIEF DESCRIPTION OF THE DRAWINGS

These and other objects and advantages of this invention will become more fully apparent from the following detailed description taken with the accompanying drawings in which:

FIG. 1 is a diagram showing the outline configuration of an SPLEEM that conducts a magnetic domain observation;

FIG. 2 is a diagram for explaining the configuration of an embodiment of the present invention;

FIG. 3 is a diagram for explaining the configuration of another embodiment of the present invention;

FIG. 4 is a diagram for explaining the configuration of still another embodiment of the present invention;

FIG. 5 is a diagram for explaining the configuration of still another embodiment of the present invention;

FIG. 6 is a diagram for explaining an image data processing system according to an embodiment of the present invention;

FIG. 7 is a diagram for explaining an example of a flowchart of an SPLEEM inspection system according to the present invention since a specimen is set until an image is obtained;

FIG. 8 is a diagram for explaining another example of a flowchart of an SPLEEM inspection system according to the present invention since a specimen is set until an image is obtained;

FIG. 9A is a diagram for explaining an example of the definition of a parameter of a data obtaining format in the SPLEEM inspection system of the present invention;

FIG. 9B is a diagram for explaining an example (B) of the data obtaining format;

FIG. 10 is a diagram showing an example of a data analyzing method according to the present invention;

FIG. 11 is a diagram showing another example of a data analyzing method according to the present invention; and

FIG. 12 is a diagram for explaining an example of a flowchart of from the image obtainment till evaluation and analysis.

### DETAILED DESCRIPTION OF THE PREFERRED EMBODIMENTS

Now, a description will be given in more detail of embodiments of the present invention with reference to the accompanying drawings.

### First Embodiment

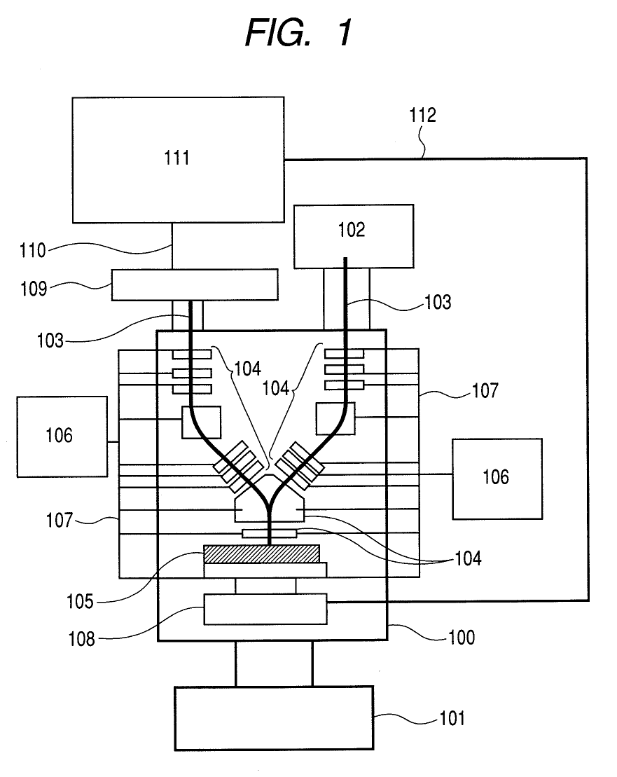

FIG. 1 is a diagram showing the outline configuration of an SPLEEM that is used in the present invention. In this example, a magnetic disk will be exemplified as a magnetic specimen.

In the SPLEEM measurement, because a sufficient signal is not taken unless the surface of a specimen is clean, the SPLEEM observation chamber 100 keeps an ultrahigh vacuum state so as not to contaminate the specimen surface, and an air is exhausted from the SPLEEM observation chamber 100 by means of, for example, an ion pump 101. The degree of vacuum of about 1×10⁻⁹ Torr is required. A spin polarized electron source 102 may provide a system in which a circular polarized light is projected to a semiconductor having an appropriate band gap such as GaAs to produce a spin polarized electron beam (reference document: Short-term research society for Physicality research “Physics developed by spin polarized electrons”, September 1993, Physicality Research “News from Physics Research”, Vol. 33, No. 3, pp 13 to 15). A spin polarized electron beam 103 that has been emitted from the spin polarized electron source 102 passes through an electron optics 104, and is then projected to a specimen 105. The electron optics 104 transports the spin polarized electron beam 103 to the specimen while electrostatically or magnetically converging the spin polarized electron beam 103. The electron optics 104 is connected to electron optics control units 106 that are power supplies that supply an electric filed or a magnetic field through high voltage cables 107. The electron optics 104 allows the electric field or the magnetic field to control not only the orbit of the spin polarized electron beam 103 but also the orientation of the spin polarized vector. Also, the electron optics 104 is capable of accelerating the spin polarized electron beam 103 up to several tens kV, but decelerates the spin polarized electron beam 103 down to about 10 V or lower immediately before the spin polarized electron beam 103 is projected to the specimen 105. This is because the incident spin polarized electron beam 103 cannot enter the deep portion of the specimen 105 in order to ensure the reflectivity that reflects the magnetization state of the surface through the SPLEEM principle.

The specimen 105 is set up in a rotary stage 108, and conducts a rotary motion and a linear motion in the radial direction as the inspection is advanced, so that the spin polarized electron beam 103 is projected to all of the areas to enable the inspection. The spin polarized electron beam 103 that has been reflected by the specimen surface is again transported by the electron optics 104, and focused on a screen 109. The screen 109 may be, for example, of the CCD system. Also, it appears that a TDI system is effective as a system that integrates data from the specimen which always moves in order to enhance the S/N.

The data that has been obtained from a focusing system is transferred to an image processing system 111 through a signal transfer cable 110. The image processing system 111 arranges the transferred data, for example, in a rotary coordinate system, and numerically analyzes the data, to thereby determine whether a contrast base on the magnetization has been obtained, or not, inspect the recording bit structure by the aid of the Fourier transformation, and saves a defective portion with a marker when the defective portion has been found. In managing those coordinates, it is necessary that the image processing system 111 exchanges information with respect to the rotary stage 108 through the transmission cable 112. A portion that conducts the SPLEEM measurement is a main portion in the system according to the present invention.

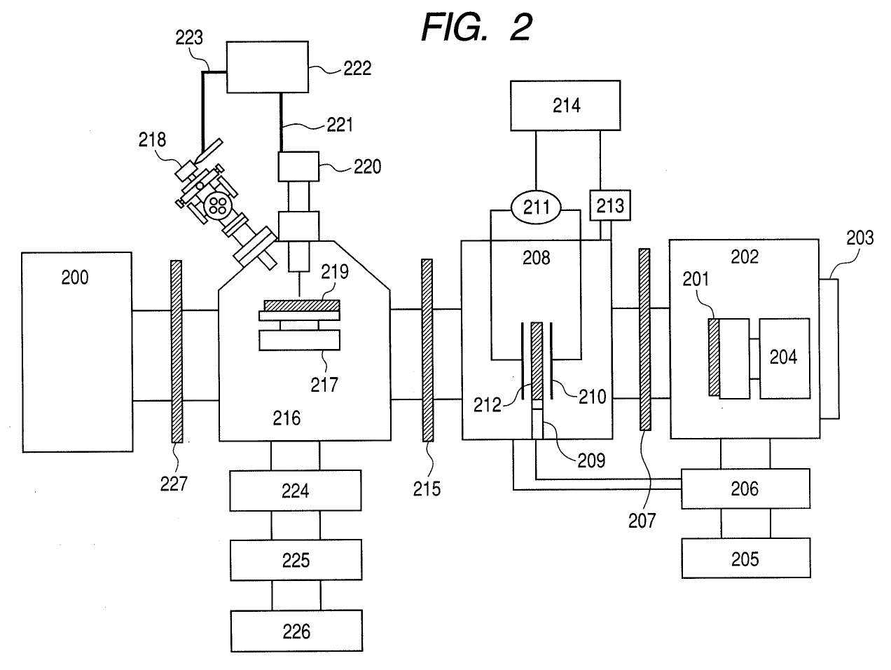

FIG. 2 shows an SPLEEM system according to an embodiment of the present invention. In the figure, the entire portion that conducts the SPLEEM measurement shown in FIG. 1 is simply indicated as an SPLEEM observation chamber 200. The entire device is mainly made up of four vacuum chambers. A specimen 201 is first inserted into a load lock 202 through a door 203, and set in a load lock stage 204. After the specimen has been inserted into the load lock 202, an air is exhausted from the load lock 202 by the aid of, for example, a rotary pump 205 or a turbo molecular pump 206 at a high speed, and the degree of vacuum may be set to about 1×10⁻⁷ Torr.

After a vacuum is sufficiently created, a gate valve 207 is opened, and the specimen is transported to an oxygen ashing chamber 208 and fixed to an ashing stage 209. The oxygen ashing is a manner in which an RF power supply 211 is connected to an electrode 210 in the oxygen atmosphere, oxygen is plasma-enhanced, and organics on the surface of the specimen 212 is chemically removed. Through the above process, for example, it is possible to remove a protection layer on the magnetic disk. Therefore, it is necessary to introduce oxygen gas during ashing, and an oxygen tank 213 is required. The entire ashing process such as an output of the RF power supply or a pressure of oxygen gas is controlled by the ashing control unit 214. The degree of vacuum may be, for example, about 1×10⁻⁷ Torr, and is further degraded when ashing is conducted with the introduced oxygen. In the figure, the load lock 202 and the exhaust pump are commonly used, but may be separated.

After completion of the oxygen ashing, the oxygen gas introduction stops to again enhance the degree of vacuum, the gate valve 215 is opened, and the specimen 212 is transported to a milling chamber 216 and fixed to a milling stage 217. In the chamber, the surface of the specimen 219 is physically ground by the aid of accelerated argon ions that are projected from an ion gun 218, to thereby clean the surface of the specimen 219. As the cleaning conditions, when ions are accelerated with a high voltage, there is a fear that the crystallinity is destroyed such that the ions are inserted into the magnetic film, thereby making it necessary to conduct the cleaning at a lower acceleration. However, since it takes time to conduct milling even when the acceleration is too low, for example, about 200 to 500 V are proposed. Since it is necessary to mill a single disk, the milling stage 217 is capable of conducting the rotation and translation motion.

As a method of determining how much milling has been completed, there is a method in which an Auger analysis system monitors the kind of outermost surface elements. The Auger analysis system monitors an oxygen peak or a peak of magnetic elements such as cobalt from a milling start in advance through the Auger analysis method, and transfers the signal to a control unit 222 through a transmission cable 221 in the case where the decrement of the oxygen peak or the increment of the magnetic element peak reaches a given value. The control unit transfers the signal to the ion gun 218 through the transmission cable 223, and stops milling. In the case of using no milling mechanism, the vacuum exhaust system exhausts an air from the milling chamber 216 by the aid of an ion pump 224 in order to keep the ultrahigh vacuum state of, for example, about 1×10⁻⁹ Torr. Also, because argon gas is exhausted when milling, the degree of vacuum is degraded down to, for example, about 1×10⁻⁷ Torr. For that reason, a turbo molecular pump 225 and a rotary pump 226 are used.

When the milling has been completed, and the vacuum in the milling chamber 216 is recovered, a gate valve 227 is opened, and the specimen is transferred to the SPLEEM observation chamber 200 shown in FIG. 1. Then, the magnetic domain structure of the specimen is inspected by the SPLEEM measurement.

### Second Embodiment

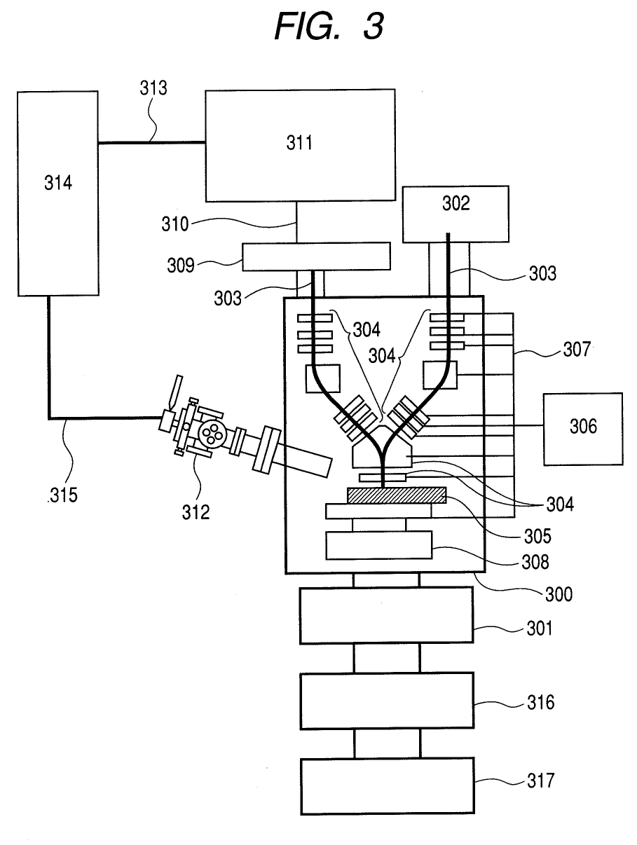

FIG. 3 shows another embodiment of the present invention. In this embodiment, the milling chamber 216 and the SPLEEM observation chamber 200 in FIG. 2 are integrated together, and a portion associated with the ashing process and the specimen introducing process other than the above integrated portion in FIG. 2 will be omitted. Also, the structure of the SPLEEM observation portion in FIG. 3 is basically identical with that in FIG. 1, and parts corresponding to reference numerals 300 to 311 in the figure have the same functions as those of reference numerals 100 to 111 in FIG. 1. In the figure, a transmission cable that connects the electron optics control unit of the focusing system and the high voltage cable, and a transmission cable that connects an image processing device 311 and a rotary stage 308 are omitted.

In other words, this embodiment is configured such that an ion gun 312 is installed in an SPLEEM observation chamber 300 within the same vacuum chamber. The ion gun 312 adjusts the optical axis so as to mill a given range of the specimen 305, but that portion is so adjusted as to be a portion that is subjected to the SPLEEM observation by thereafter immediately rotating the specimen. For that reason, because the SPLEEM observation is conducted immediately after milling, observation can be performed in a state where the stain of the specimen surface due to the residual gas within the chamber is hardly attached. Also, when the specimen is sequentially rotated, and a portion on a circumference having a given radius is continuously subjected to the milling and the SPLEEM observation, a state in which the SPLEEM image is not initially obtained because the specimen surface is stained is changed to a state in which the image is obtained when a certain time elapses, the milling is advanced, and the surface is cleaned. In the case where the image is obtained with a sufficient S/N, information is transmitted to an ion gun control unit 314 from an image processing device 311 through a transmission cable 313 to stop the milling. The information from the ion gun control unit 314 to the ion gun 312 is transmitted through a transmission cable 315.

In the above system, there is advantageous in that an appropriate amount of milling can be directly measured in the SPLEEM observation as well as the Auger analysis system is not required. On the contrary, a milling turbo molecular pump 316 or a rotary pump 317 are required for the chamber that conducts the SPLEEM observation.

### Third Embodiment

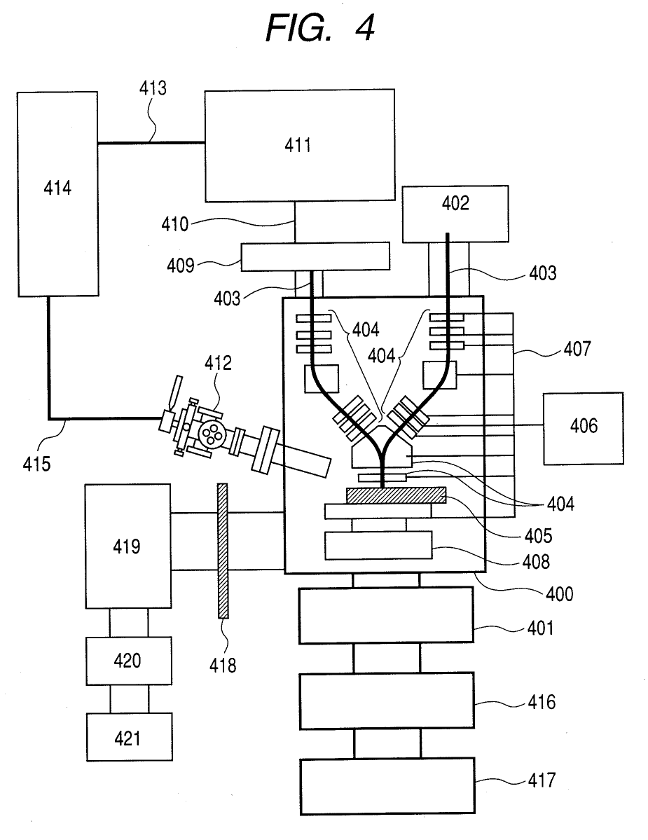

FIG. 4 shows still another embodiment of the present invention. Likewise, in this embodiment, a milling ion gun 412 is mounted in an SPLEEM observation chamber 400, and the SPLEEM observation can be performed in parallel with the milling. In the figure, the structure of the SPLEEM observation portion is basically identical with that in FIG. 3, and parts corresponding to reference numerals 400 to 417 in FIG. 4 have the same functions as those of reference numerals 300 to 317 in FIG. 3. A transmission cable that connects the electron optics control unit of the focusing system in the SPLEEM mechanism and a high voltage cable, and a transmission cable that connects an image processing device 411 and a rotary stage 408 are omitted.

The embodiment shown in FIG. 3 assumes the ashing process shown in FIG. 2 at a prestage, but this embodiment is so configured as to mill a specimen that has been brought from the atmosphere as it is. For that reason, a specimen introduction chamber 419 is attached to the structure through a gate valve 418. Also, a turbo molecular pump 420 and a rotary pump 421 are attached to the structure for air exhaust.

This embodiment is suitable for observation of the specimen which does not require the removal of organics such as a device having no protection layer, and provides the device configuration as simple as the ashing mechanism is not required.

### Fourth Embodiment

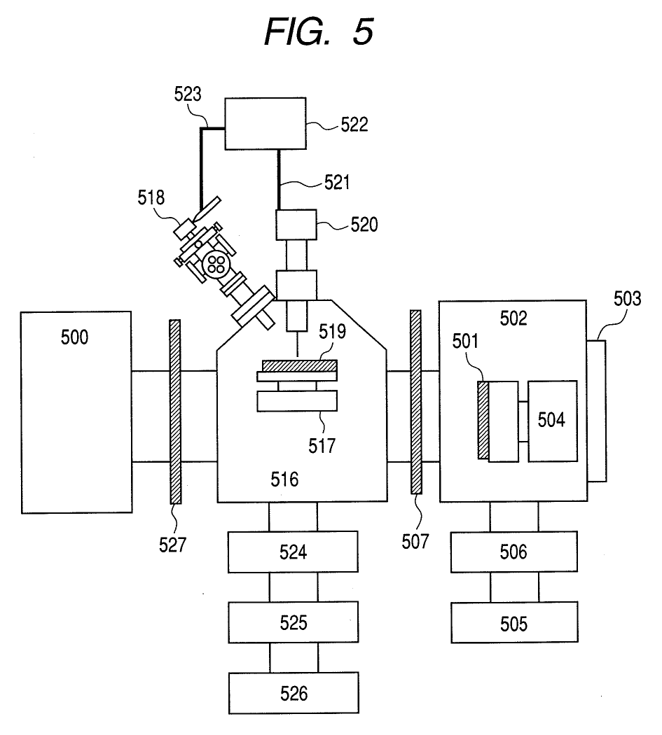

FIG. 5 shows still another embodiment of the present invention. Likewise, in this embodiment, no ashing mechanism is disposed as in the embodiment shown in FIG. 4. Reference numeral 500 at the left of the figure denotes an SPLEEM observation chamber although being simplified, and has the same function as that in FIG. 1. A difference from the embodiment in FIG. 4 resides in that this embodiment is similar to the system shown in FIG. 2 in which the ion milling and the SPLEEM observation are separated in different chambers. Parts corresponding to reference numerals 500 to 507 and 516 to 527 in FIG. 5 have the same functions as those of reference numerals 200 to 207 and 216 to 227 in FIG. 2.

Similarly, this embodiment is suitable for observation of the specimen that does not require the removal of organics such as a device having no protection layer, and is capable of realizing the device configuration as simple as no ashing mechanism is required.

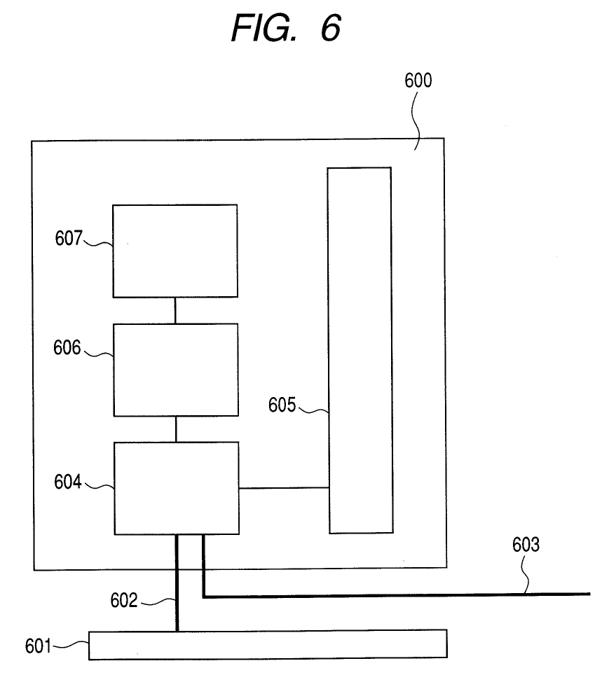

Subsequently, one structural example of the image processing system according to the above first to fourth embodiments will be shown in FIG. 6. The data indicative of the number of electrons which are obtained from a screen 601 is transferred to an image processing device 600 through a transmission cable 602. Also, the information from the rotary stage is transferred through a transmission cable 603. The data is first transformed into numeric data by means of a data transformation unit 604, and the data is transferred to a display unit 605 and an analysis unit 606. An analysis unit 606 arranges the transferred data in the rotary coordinates and subjects the data to the Fourier transformation to check the defective portion. The data of obtained defective portions is stored in a saving unit 607.

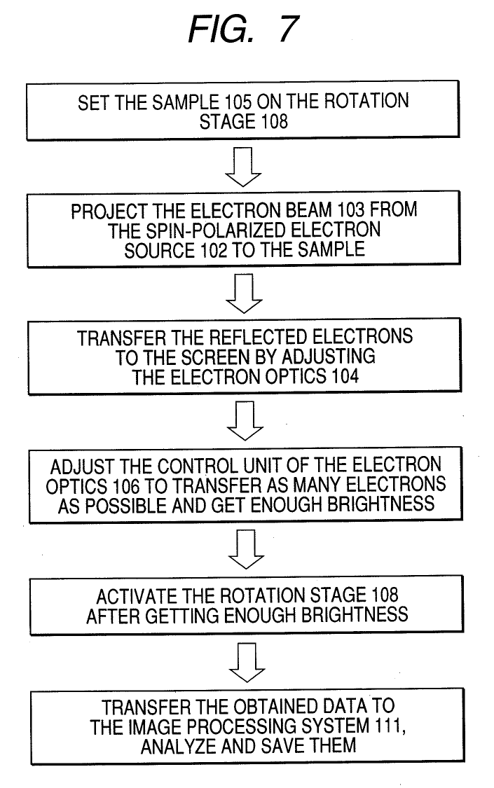

FIG. 7 shows an example of a flowchart in the SPLEEM inspection system according to the present invention since the specimen is set until an image is obtained. In this example, a description will be given of, for example, a case of the above-mentioned first embodiment having the configuration of the SPLEEM observation unit shown in FIG. 1. First, the specimen 105 that has completed the preprocessing is set on the rotary stage 108. Then, the electron beam 103 is projected to the specimen from the spin polarized electron source 102. Then, the electron beam 103 that has been reflected from the specimen 105 is transferred to the screen 109. In this situation, the electron optics 104 between the spin polarized electron source 102 and the specimen 105, and the electron optics 104 between the specimen 105 and the screen 109 serve to transfer the electron beam 103 without any loss. Each of the electron optics 104 is made up of several electron lenses, and transfers the electron beam 103 while converging the electron beam according to voltages that are applied to the respective lenses. Therefore, in order to sufficiently obtain the luminance of the screen 109, it is necessary to adjust the electron optics control unit 106. When the sufficient luminance of the screen 109 is obtained by adjustment of the electron optics control unit 106, the rotary stage 108 is actuated to sequentially obtain the magnetic domain image, and the data is transferred to the image processing system 111.

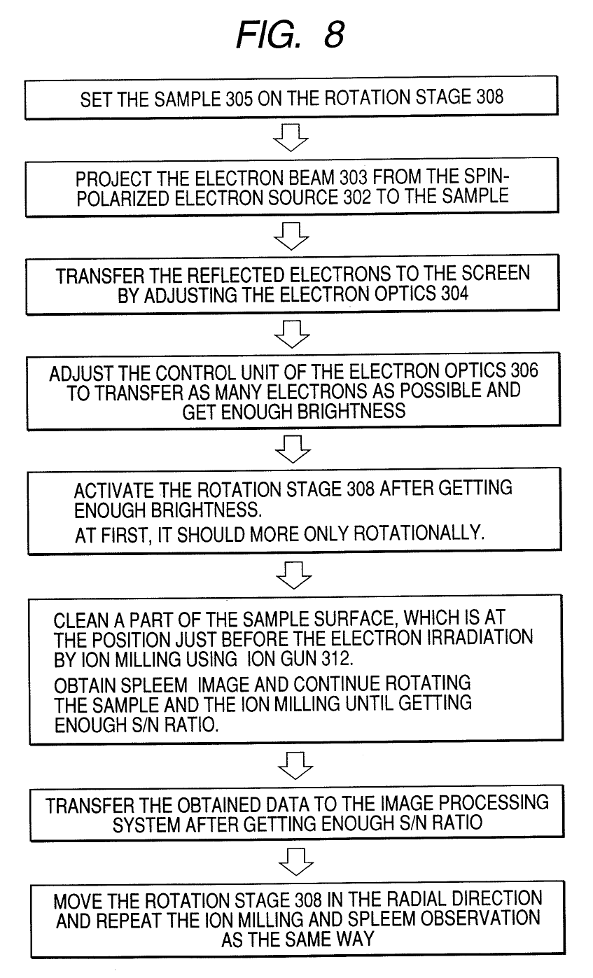

Likewise, FIG. 8 shows, for example, a case of the above-mentioned second embodiment having the configuration of the SPLEEM observation unit shown in FIG. 3. In this case, after the electron optics 304 has been adjusted, the rotary stage 308 is rotated, the electron beam 303 is projected, and a portion immediately before being subjected to the SPLEEM observation is ion-milled by means of the ion gun 312. At first, the magnetic domain contrast is not obtained because the ion milling is not sufficient. However, while it takes time to rotate the specimen several rounds, the sufficient milling is conducted on the specimen to obtain the magnetic domain contrast. In this stage, an image is obtained. When the image for one round can be obtained, the rotary stage is moved in the radial direction, a location for the observation and the milling is moved, and the same operation is conducted.

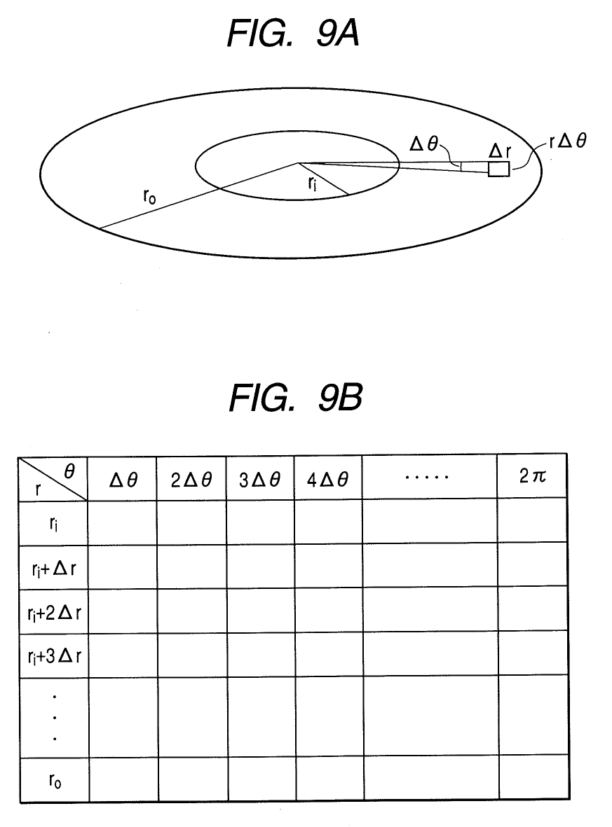

FIGS. 9A and 9B show an example of a rotary coordinate format that is used in conducting data analysis or saving. FIG. 9A shows a relationship of the respective parameters on the disk specimen. It is assumed that the radii of the inner periphery and the outer periphery of the disk are ri and r0, respectively, and the step sizes of data in the radial direction and at the circumferential angle are Δr and Δθ, respectively. An area that is surrounded by each of Δr and rΔθ is indicative of a parameter associated with the resolution of the SPLEEM image, which corresponds to one pixel in one picture. That is, the area must be smaller than an area that is imaged by the electron beam at once. FIG. 9B shows an example in which the respective data is mapped by using the rotating coordinates (r, θ). Since the data is obtained by using the rotary stage, for example, r is first fixed, and the images are sequentially taken while rotating the disk. In the case where the screen is of the CCD system, there is proposed a system in which the stage is made stationary, data is obtained, the image data is transformed into a numeric value, and some of columns indicated by FIG. 9B are filled with the data, and the subsequent data is obtained by rotating the stage. The amount of moving the stage is substantially as large as the area that is imaged at once, which is larger than rΔθ. Also, in the case of the TDI system, the disk is always rotated, and the image is taken every movement unit which is smaller than the electron projected area (which is equal to or larger than rΔθ), and then transformed to a numeric value. The numeric value is superimposed on the adjacent data to improve the S/N, and the columns are filled with the obtained data. After one revolution (from Δθ to 2Π) has been made, the rotary stage is shifted in the radial direction, and the data is sequentially taken again while the rotary stage is rotated in the θ direction. It is needless to say that the movement size in the r direction is larger than Δr, and depends on the size of the data area that can be obtained by the SPLEEM at once.

As described above, the stage repeats the rotary motion and the parallel motion in the radial direction, to thereby first obtain the data in the lateral direction, and after the disk has rotated one round, data is obtained so as to fill the next column shifted by one line in the vertical direction with the data in FIG. 9B. As a result, the data collection is simple, and an analysis for obtaining a difference of the data or the mean value thereof is facilitated. Also, even in the case where the format of the magnetic information is changed in a range of θ which is provided for a servo information unit, the circumferential coordinate indication of this type is readily distinguishable. Also, when Δθ is identical between the inner periphery and the outer periphery, the step size of the outer periphery at the distance of the disk in the circumferential direction is larger than that of the inner periphery. Since this leads to the possibility that the resolution of the inspection is different between the inner periphery and the outer periphery, there is a system in which Δθ is changed between the inner periphery and the outer periphery.

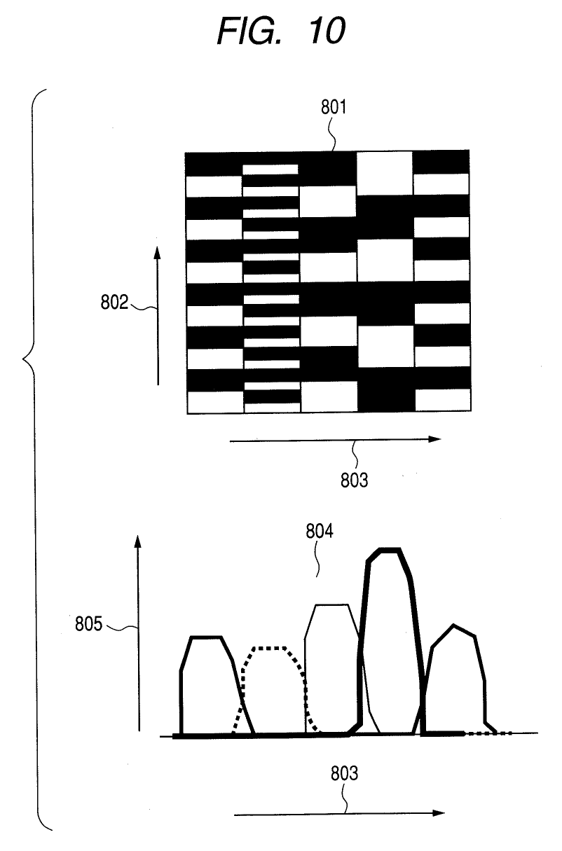

FIG. 10 shows an example of the data analysis method according to the present invention. The method obtains the magnetic domain image corresponding to the information that has been recorded as an SPLEEM image 801. In this example, an area (for example, a servo area) in which recording units of a single wavelength are arranged in a peripheral direction (or the tracking direction) 802 is exemplified. An example 804 of the Fourier transformation that has been obtained by that data is shown at a lower portion of FIG. 10. The data of the inspection area is subjected to the Fourier transformation in the tracking direction, and the magnitude 805 of the amplitude of the frequency component by the recording unit is plotted in a radial direction (or the track width direction) 803. As a result, the magnitude or width of the respective frequency component amplitudes is analyzed to determine whether the state is abnormal, or not.

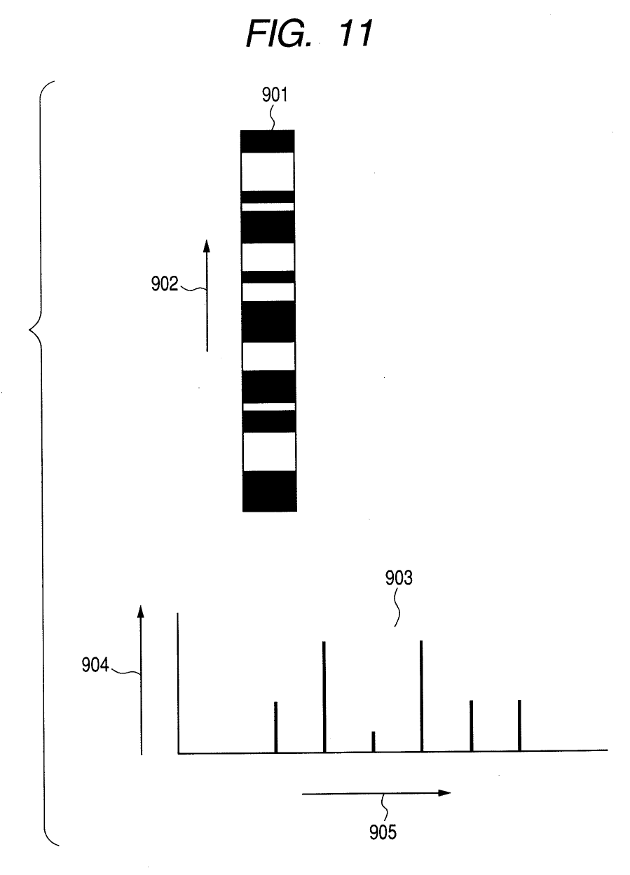

FIG. 11 shows another example of the data analysis method according to the present invention. This method obtains the magnetic domain image corresponding to the information that has been recorded as an SPLEEM image 901. In this embodiment, an area in which recording units each having a different wavelength are arranged on one track is exemplified. The area is subjected to the Fourier transformation in a tracking direction 902, and the magnitude of the wavelength of the respective frequency components is plotted at a lower portion 903 of the figure. In the drawing, the axis of ordinate 904 represents the magnitude of the amplitude of the respective frequency components, and the axis of abscissa 905 is a frequency. When the amplitude of the recorded frequency component is smaller, or the frequency component that has not been recorded appears, it is determined as the abnormality. Also, in the case of obtaining a frequency that is larger than the maximum recording frequency, there is the possibility that the magnetic domain structure is abnormal, or a fine foreign matter adheres to the specimen. The above results are stored in a data saving unit together.

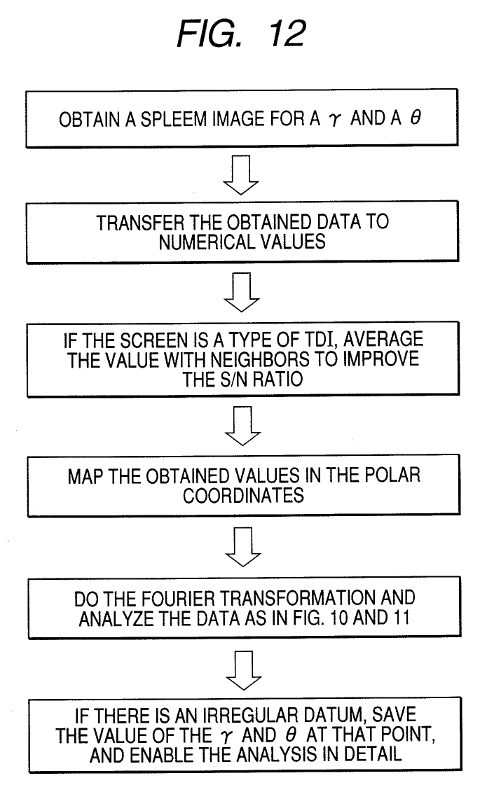

FIG. 12 shows an example of a flowchart conducted from the image obtainment till the evaluation and analysis according to the present invention. Let us consider a case in which the SPLEEM image is obtained in certain r and θ. In the case where the obtained image is quantified, and the screen is of the TDI system, the quantified image is superimposed on the data that has been obtained before and after to improve the S/N, and the obtained data is mapped in the circumferential coordinate system shown in FIG. 9B. Thereafter, the mapped data is subjected to the Fourier transformation, the data analysis shown in FIGS. 10 and 11 is conducted, and the coordinates are saved in the case where there is found the abnormality. Then, r and θ at that portion are saved, separately, for the purpose of the subsequent detailed analysis.

As described in detail above, according to the present invention, the SPLEEM manner can be used in the manner of inspecting the magnetic specimen such as the magnetic device. As a result, there can be provided the magnetic domain observing technique that is high in the resolution and high in the speed as never before, and a method of analyzing the obtained data.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A magnetic specimen inspection instrument, comprising:
an SPLEEM observation unit including: a spin polarized electron source; an irradiation optics that projects a spin polarized electron beam that is emitted from the spin polarized electron source to a magnetic specimen having a magnetic domain structure; a stage on which the magnetic specimen is mounted; an imaging optics that focuses and detects the electron beam that is reflected from the magnetic specimen; and
cleaning means for cleaning the surface of the magnetic specimen to transfer the magnetic specimen to the SPLEEM observation unit,
wherein the magnetic domain structure of the magnetic specimen surface is inspected on the basis of the reflected electron beam.

2. A magnetic specimen inspection instrument, comprising:
an SPLEEM observation unit including: a spin polarized electron source; an irradiation optics that projects a spin polarized electron beam that is emitted from the spin polarized electron source to a magnetic specimen having a magnetic domain structure; a stage on which the magnetic specimen is mounted; an imaging optics that focuses and detects the electron beam that is reflected from the magnetic specimen;
cleaning means for cleaning the surface of the magnetic specimen to transfer the magnetic specimen to the SPLEEM observation unit; and
an image processing unit that analyzes the image data that is obtained from the imaging optics,
wherein the magnetic domain structure of the magnetic specimen surface is inspected on the basis of the image data.

3. The magnetic specimen inspection instrument according to claim 1 or 2, wherein the cleaning means includes an ion milling mechanism that cleans the magnetic specimen surface; and a plasma ashing mechanism that removes organics of the magnetic specimen surface.

4. The magnetic specimen inspection instrument according to claim 3, further comprising:
a first vacuum chamber that receives the SPLEEM observation unit therein;
a second vacuum chamber that receives the ion milling mechanism therein; and
a third vacuum chamber that receives the plasma ashing mechanism therein,
wherein the first vacuum chamber, the second vacuum chamber, and the third vacuum chamber are connected to each other through gate values.

5. The magnetic specimen inspection instrument according to claim 4, further comprising: a fourth vacuum chamber for introduction of the magnetic specimen,
Wherein the fourth vacuum chamber is connected to the third vacuum chamber through the gate value.

6. The magnetic specimen inspection instrument according to any one of claims 1 to 5, wherein the stage means conducts the rotary motion and the linear motion in the radial direction, or is activated in the lateral and vertical directions.

7. The magnetic specimen inspection instrument according to claim 1 or 2, wherein the cleaning means has an ion milling mechanism that cleans the magnetic specimen surface.

8. The magnetic specimen inspection instrument according to claim 7, further comprising:
a first vacuum chamber that receives the SPLEEM observation unit therein; and
a second vacuum chamber that receives the ion milling mechanism therein,
wherein the first vacuum chamber and the second vacuum chamber are connected to each other through a gate value.

9. The magnetic specimen inspection instrument according to claim 8, further comprising:
a fourth vacuum chamber for introduction of the magnetic specimen,
wherein the fourth vacuum chamber is connected to the second vacuum chamber through a gate valve.

10. The magnetic specimen inspection instrument according to any one of claims 7 to 9, wherein the stage means conducts the rotary motion and the linear motion in the radial direction, or is actuated in the vertical and lateral directions.

11. The magnetic specimen inspection instrument according to claim 1 or 2, wherein the cleaning means includes an ion milling mechanism that cleans the magnetic specimen surface, and
wherein the ion milling mechanism is located within the first vacuum chamber that receives the SPLEEM observation unit therein.

12. The magnetic specimen inspection instrument according to claim 11, further comprising a fourth vacuum chamber for introduction of the magnetic specimen,
wherein the fourth vacuum chamber is connected to the first vacuum chamber through a gate valve.

13. The magnetic specimen inspection instrument according to claim 11 or 12, wherein the stage means conducts the rotary motion and the linear motion in the radial direction, or is actuated in the vertical and lateral directions.

14. The magnetic specimen inspection instrument according to claim 2, wherein the image processing unit subjects the magnetic domain image that is obtained by the SPLEEM observation unit to a Fourier transformation process in the tracking direction to inspect the magnetic domain structure.

15. The magnetic specimen inspection instrument according to claim 14, wherein the image processing unit subjects the obtained magnetic domain structure to a Fourier transformation in the tracking direction, and thereafter analyzes the amplitude of the frequency component of the recording bit that is formed on the magnetic disk surface to inspect the magnetic domain structure according to the magnitude of the amplitude and the broadening of the track in the widthwise direction.

16. The magnetic specimen inspection instrument according to claim 14, wherein the image processing unit subjects the obtained magnetic domain structure to a Fourier transformation in the circumferential direction, and thereafter analyzes the amplitude of the frequency component of the recording bit that is formed on the magnetic disk surface and inspect the magnitude of the amplitude of the respective frequency components to inspect the magnetic domain structure.
